(19) United States
(12) Patent Application Publication
(10) Pub. No.: US 2013/0022812 A1
(43) Pub. Date: Jan. 24, 2013

(54) HIGH WATER ACTIVITY CARBON CONTAINING OXYGEN ABSORBER

(71) Applicants: Thomas H. POWERS, Mayville, NY (US); John W. Crump, Buffalo, NY (US)

(72) Inventors: Thomas H. POWERS, Mayville, NY (US); John W. Crump, Buffalo, NY (US)

(73) Assignee: Multisorb Technologies, Inc., Buffalo, NY (US)

(21) Appl. No.: 13/185,741

(22) Filed: Jul. 19, 2011

(51) Int. Cl. B32B 7/12; B32B 15/04; C09K 3/00

(52) U.S. Cl. 428/343; 252/184; 428/457

(57) ABSTRACT

The invention provides an oxygen absorbing article comprising carbon, iron, refined wood pulp, and water. In another embodiment the invention provides an oxygen absorbing article comprising a base sheet, a cover sheet secured to said base sheet to define a closed space there between, a first layer of oxygen absorbing materials in integral layer form in said closed space, wherein the oxygen absorbing materials comprises carbon, iron, refined wood pulp, and water.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

Many products are susceptible to putrefaction, denaturation, mold growth, spoilage, rancidity, oxidation, or other deterioration when brought into contact with oxygen. Examples of such products include beer, wine, juice, vinegar, sauces, seasonings, processed foods, bread, produce, meats, and certain pharmaceuticals and chemicals, among a variety of others. Preservation of such products is disturbed when molds, bacteria, and other organisms that thrive in the presence of oxygen are present. These organisms cause the putrefaction and change in the taste or quality of the product. In addition, some of the products themselves are liable to be affected by oxidation that changes the taste or quality of the product. To prevent such oxidation and growth of organisms and thus increase the preservation stability of these products, the oxygen must be removed from the container in which the products are stored.

One technique for avoiding or reducing the presence of oxygen is vacuum packing. This involves evacuating a container before charging it with the product.

Another technique is gas displacement. Here, an inert gas such as nitrogen is used to displace the air and hence the oxygen in a container. The displacement can be performed before or after the product is charged to the container. This technique is expensive and it is difficult to displace all oxygen.

Still another technique is a foaming method. Particularly applicable to products such as beer, a jet foamer can be used to inject a small amount of pressurized water to foam the beer after charging it to the container. The foam acts as a mechanical deoxygenizer.

Common disadvantages associated with all of the above techniques are the requirement of large-scale apparatus and operation and the difficulty of removing oxygen dissolved in the product. Also, in general, these techniques leave between 0.2% and 5.0% of the oxygen in the container. This amount of oxygen in the container is enough to adversely affect many products.

A simpler, more efficient technique for oxygen removal involves placing an oxygen absorbent in the container with the product. For this purpose, it is known to dispose an oxygen absorbent within a resin that is solid at room temperature. For example, in U.S. Pat. No. 5,143,763, compositions are disclosed having an oxygen absorbent disposed in a resin such as polyethylene, polypropylene, and ethylene-vinyl acetate copolymer, among others. U.S. Pat. No. 5,089,323 discloses compositions having an oxygen absorbent contained in thermoplastic resins such as low-density branched polyethylene, high-density polyethylene, propylene homopolymers, and copolymers of ethylene and vinyl acetate, among others.

Because the resins in these examples are solids at room temperature, application of the resin-oxygen absorbent mixture is often difficult. Accordingly, the '763 reference suggests dissolving the resin in a solvent to form a resin solution to facilitate application of the mixture. Specifically, the processes of forming a solution having an oxygen absorbent in it and applying it by screen printing are disclosed in the '763 reference. It is known to form labels with oxygen absorbing properties utilizing iron particles. Such materials are disclosed in U.S. Pat. No. 5,667,863—Cullen et al. U.S. Pat. No. 5,641,425—McKedy et al. discloses an oxygen absorbing composition that may be in the form of a label.

However there has been a continuing need for an oxygen absorber that is operable in high water environment. Further, there is a desire for oxygen absorbers that assist in odor control. An oxygen absorber for moisture bakery products such as bread that will not remove water from the bakery item but will have good oxygen absorption to prevent the oxidation of the bakery product and minimize mold growth is needed.

### FIELD OF THE INVENTION

This invention relates to a high water activity carbon containing oxygen absorber, preferably in label form.

### BRIEF SUMMARY OF THE INVENTION

The invention provides an oxygen absorbing article comprising carbon, iron, refined wood pulp, and water.

In another embodiment the invention provides an oxygen absorbing article comprising a base sheet, a cover sheet secured to said base sheet to define a closed space there between, a first layer of oxygen absorbing materials in integral layer form in said closed space, wherein the oxygen absorbing materials comprises carbon, iron, refined wood pulp, and water.

### BRIEF DESCRIPTION OF THE SEVERAL VIEWS OF THE DRAWING(S)

FIG. 1 is a fragmentary plan view of a web containing oxygen absorbing articles of the invention.

FIG. 2 is a fragmentary cross-section taken substantially along line 2-2 of FIG. 1 showing an embodiment of the oxygen absorbing article of the invention.

### DETAILED DESCRIPTION OF THE INVENTION

This invention provides an improved method of storage, particularly for bakery products. The invention allows the bakery products to be stored for a longer period and without being dehydrated. The invention further allows the products to not give off an unpleasant odor after storage. The product in preferred form is a solid sheet that when in a package is not likely to become loose and be handled, broken, or eaten by the consumer. The maintaining of high moisture bakery product improves the flavor, mouth feel, and shelf life of the product. By not absorbing significant moisture from the product there are significant advantages over the oxygen absorbers that required consumption of moisture from the stored product in order to become operable and absorb oxygen. This is a significant advantage as it allows successful use of the invention oxygen absorbers with high moisture bakery products. The oxygen absorbent composition of the invention also adheres better to cardstock than previous compositions. The invention materials further have lower cost than those in prior products as well as absorbing odors. These and other advantages will be apparent from the description below.

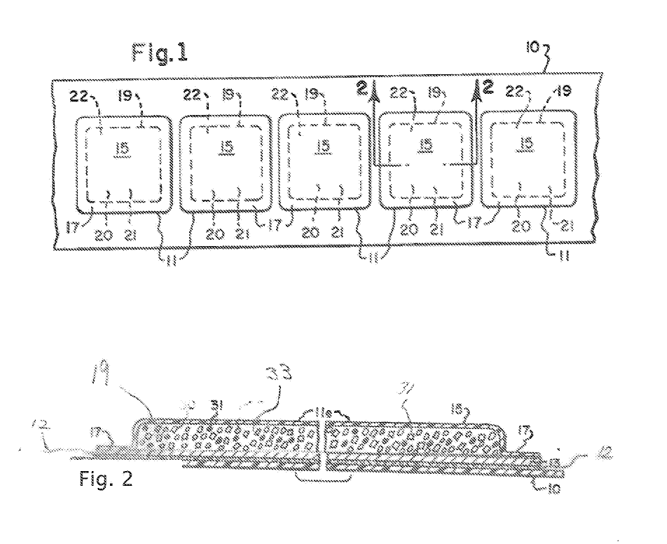

In FIG. 1, a web 10 is shown containing a plurality of flexible oxygen-absorbing labels 11. FIG. 2 is the cross-section of a label of the present invention. Each label 11 is secured to a web 10, which is fabricated of release paper so that each label 11 can be removed therefrom, by a 1 to 2 mil layer 12 of adhesive which may be any suitable pressure-sensitive adhesive. The adhesive 12 forms the underside of base sheet 13 which may be made of suitable paper cardstock or flexible plastic film 1 to 5 mils in thickness and preferably 2 to 3 mils in thickness made of styrene copolymer. The flexible base sheet 13 may be moisture or vapor impervious or it may be moisture-absorbent, if moisture will not deteriorate it. If the labels are to be attached to a container by hot melt adhesive or heat-sealable polymer, layer 12 can be made of such substances and layer 12 can be releasably secured to a web 10 by any suitable means, such as an additional layer of pressure sensitive spots of suitable adhesive. The adhesive attachment to the web 10 is by way of example only, and it will be appreciated that the labels may be attached to each other at their borders and thus the labels themselves may be formed into a web. In these embodiments, the labels may be separated from the web 10 by suitable cutting machinery or they can be torn from the web along perforations between the labels. U.S. Pat. No. 6,139,935 is hereby incorporated by reference to show known web forming techniques for oxygen absorbers. The thicknesses of the various layers may vary, especially the thickness of the oxygen absorber depending on the amount of absorption which is required.

The upper surface of base sheet 13 is sealed to sheet 15 by hot melt adhesive or heat-sealable polymer. Also, sheet 15 can be attached to its base 13 by any other suitable means including but not limited to heat-sealing, ultrasonic welding, and the various forms of attachment can be used by themselves or in suitable combinations with each other. The various forms of adhesive may include, without limitation, pressure sensitive adhesive, hot melt adhesive, cold glue, and catalytically cured resin.

A flexible top sheet 15 is secured to a base sheet 13 by means of the adhesive or heat sealing and this securement is around peripheral edge 17. By way of example and not limitation, the top sheet 15 is fabricated from oil and water impermeable paper, coated paper, or plastic film, such as polyethylene, polypropylene, EVA or polyethyleneterephthalate, surlyn, paper, or laminates thereof. The laminate in a preferred form is a vapor permeable spunbond sheet, such as Tyvek® a polyethylene polymer spunbond fiber sheet, combined with an outer surface of a gas permeable acetate sheet. Furthermore, by being oil and water impermeable, the upper sheet 15 will not stain and thus will resist discoloration to prevent an unsightly appearance in use. The staining which is resisted is that due to the oxidation of the iron contained in the label or due to contact with the contents of the container in which the label is placed. The top sheet may be between 1 and 9.5 mils in thickness and, more preferably, between 2 and 7 mils in thickness and, most preferably, between 2 and 4 mils in thickness for good strength and permeability.

The top sheet 15, by virtue of its attachment to the bottom sheet 13 at the peripheral edge 17, encloses the oxygen absorbing components 19 therein. The oxygen absorbing components are cast onto layer 13 and allowed to solidify into an integral layer prior to being covered by layer 15. In view of the high water content, and the casting techniques from water, only the iron particles 31 are clearly defined in the cross section of FIG. 2. The matrix 33 of the layer 19 contains all the other ingredients. The iron 31 may be either hydrogen reduced iron or electrolytically reduced iron, or chemically reduced iron which will provide greater reactivity. While iron is preferred as the metallic oxygen-absorbing agent, because of its effectiveness, low cost, and safety it will be appreciated that other metals may be used. These are, by way of example and not limitation, aluminum, copper, zinc, titanium, magnesium, and tin. However, they do not have the oxygen-absorbing capacity of iron. Also, other elements which can be used in elemental or partially oxidized form are sodium, manganese, iodine, sulfur, and phosphorous. However, these also are not as desirable as iron.

The salt may be sodium chloride, or any other suitable food compatible salt including but not limited to sodium sulfate, potassium chloride, ammonium chloride, ammonium sulfate, calcium chloride, sodium phosphate, calcium phosphate, sodium bisulfate and sodium biphosphate, and magnesium chloride. For non-food products, other non-food compatible salts can be used. Sodium chloride is preferred to as it is effective, low cost, and safe with food.

Various dimensions for the labels of FIG. 2 have been given above and expanded ranges are given in the following table:

TABLE 1
RANGES OF THICKNESS OF LAYERS
IN FIGS. 2 AND 3 IN MILS

| | | MORE | MOST |
|---|---|---|---|
| | | PREFERRED | PREFERRED |
| LAYER | RANGE | RANGE | RANGE |
| 12 adhesive | .5 to 2 | .5 to 1.5 | .8 to 1 |
| 13 base sheet | .5 to 5 | 1 to 4 | 1 to 3 |
| 15 top sheet | 1 to 9.5 | 2 to 7 | 2 to 4 |
| 19 oxygen absorber | 1 to 32 | 2 to 12 | 4 to 8 |
| TOTAL | 3.5 to 50.5 | 6 to 261 | 8.6 to 17 |

The oxygen absorber invention, in a preferred embodiment, comprises salt (preferably sodium chloride), hydrocellulose, water, carbon and iron. The material further contains a resin emulsifier. These materials are mixed and then may be cast onto a cardstock or styrene copolymer film and partially dried. The styrene copolymer is with a polyolefin such as ethylene or butylene. The cast partially dried film after covering with layer 15 is then packaged in a package that controls excess of water vapor and oxygen so as to preserve the oxygen absorbing properties of the material.

The iron may be any suitable iron powder that is not oxidized. As noted above, hydrogen-reduced iron and electrically-reduced iron are known for oxygen absorption products and are preferred because of their ability to rapidly react to absorb oxygen.

The reduced iron powder preferably has 4-200 um mean particle size, more preferably 4-10 um mean and most preferably 10-40 um mean. The iron can be mixed with salt or a combination of different electrolytic and acidifying components. The iron particles can also be coated with salt. The combination and relative fraction of activating electrolytic and acidifying components coated onto the iron particles can be selected according to the teachings of U.S. Pat. No. 6,899,822, U.S. Patent Publication Nos. 2005/0205841 and 2007/020456, incorporated herein by reference. The coating technique is preferably a dry coating process as described in the references above.

Hydrocellulose is a refined wood pulp that has high absorbency properties as well as the ability to form emulsions or suspensions with water. It holds moisture in the invention oxygen absorber. The hydrocellulose gel is preferred as it is absorbent and forms a good oxygen absorbing layer with the iron and carbon.

Any suitable activated carbon may be utilized in the invention. Typically, the activated carbon would have an average particle size between 1.0 mm and 0.15 mm. A preferred size is between 0.15 mm and 0.25 mm for good water and gas absorption. Activated carbon is very porous and therefore has a very high surface area. Activated carbon is suitable in this invention both to hold water and to absorb odors from the packaged products such as bakery goods. The carbon, while capable of absorbing odors, also may be loaded prior to oxygen absorber formation with an odor that it will give off and add to the package, such as a fresh backed odor or a fruit odor for blueberry and strawberry containing baked goods.

The emulsifier may be any product that will keep the dry ingredients emulsified and suspended. These materials may be what was sorbitol fatty acids. A suitable material is polyethylene sorbitan monooleate. A preferred material is polyoxyethylenesorbitan monoleate (Polysorbate 80, a trademark of ICI America, Inc.) as it is an effective emulsifier in water for the hydrocellulose, carbon, and iron.

Any suitable amount of salt may be utilized. Generally, sodium chloride is preferred in the range of 1.5-5% by weight of the composition prior to being cast on cardstock or polymer sheet. The most preferred amount is between 4 and 5% for rapid absorption of oxygen.

The hydrocellulose may be utilized in any suitable amount. Typical of such amounts are between 0.5% and 5.0% percent by weight prior to lay down. Generally, a preferred amount is 4.0% and 5.0% by weight prior to lay down to provide sufficient absorption of water as is needed for this product used in high humidity.

Water is generally present in an amount of between 20 and 40% by weight of the invention oxygen absorber composition prior to being laid down on the cardstock or polymer sheet. A preferred amount is about 25% for oxygen absorber good lay down, oxygen absorption, and humidity control.

Typically, iron is present in an amount between about 40 and 60% by weight. The preferred amount of iron is between 45 and 55% by weight after mixing and prior to lay down for good casting properties of the oxygen absorbent material and adequate oxygen absorption.

The emulsifier generally is present in the range of between 0.3 and 1% by weight of the oxygen absorbent prior to lay down on cardstock or a polymer sheet. A preferred amount of the polysorbate 80 resin is about 0.5% by weight for formation of a continuous layer oxygen absorbent product.

A preferred oxygen absorbing material of the invention has the following structure:

TABLE 2

Acetate layer
Permeable layer such as Tyvek
The invention oxygen absorber layer
Cardstock or Styrene polymer sheet
Adhesive layer
Strippable cover sheet for the adhesive

The cardstock may be any suitable weight and may or may not be able to easily absorb water. The weight of the cardstock is generally between 60 and 100 lbs. The styrene polymer sheet for the base may be a styrene sheet or a copolymer with butadiene, ethylene or other olefins. A copolymer with ethylene is preferred for strength and adhesion properties.

While the invention as been described in a preferred form as a label, it is also possible that the oxygen absorbing layer of the invention could be formed onto a substrate and then placed into a water permeable, but gas permeable sachet for use. Further, it is possible that a strip of the invention material could be placed into a container that is gas permeable and the container placed into the package of food. The label is preferred as it is less likely to come into the customer's hands when the bakery package is opened than a sachet or container. The oxygen scavenging insert or article may be located in the top, bottom or against the walls of the food container.

### Example 1

First, add 30 lbs of water to a plastic pail, hydropropyl cellulose, and insert a rotary mixer, such as an Admix High Shear Mixer, and set it to 800 rpm. While mixing, add 14 lbs of Sodium Propinate hydropropyl cellulose and mix until dissolved. Once dissolved, slowly add 4.24 lbs of Klucel EF to the solution. Let it mix for 10 minutes, then add 0.64 lbs of surfactant Polysorbate 80 and continue mixing for one minute. Once complete, seal the wet mixture in a drum and let it stand for 24 hours.

As a second step, take 312 lbs. of reduced iron powder, 62 lbs of 50×200 mesh activated coconut shell carbon, and 3 lbs of powdered NaCl salt, and place it on the hopper of a Forberg twin shaft paddle mixer. Close the hopper and mix for 15 minutes. After completion, take the material out of the hopper and store in drums until needed.

Finally, just before final depositing, take 38 lbs of the wet mixture and place it in a drum. Insert a rotary mixer, such as an Admix High Shear Mixer, and mix until the material has a hazy color. Take the mixed wet material and place it in a Helix Mixer set to 15 hertz with blades rotating counter-clockwise. Then take 62 lbs of the dry mixture and place it in a standard powder feeder and set its speed so that the feeder is empty in 5 minutes. Lower the mixer blades to their lowest level, and start the mixer and powder feeder. Once empty, stop the powder feeder and continue mixing for another 7 minutes. Once complete, reduce the speed of the mixer to 6.5 hz and slowly raise the blades. Once at the top, stop the mixer and remove the combined mixture from the mixer.

Once combined, the new mixture is deposited onto a web of cardstock by standard screen printing means. 5 μms of the mixture is applied per deposit and, therefore, 5000 deposits use 5 lbs of material. The printed cardstock is then put through heat tunnels with heating plates and air dryers. The plates should be at 100° F. and the air dryer at 115° F. Speed of the line and duration in the tunnel are dependent upon the volume of the deposits, with the goad being that the deposits are pliable upon exiting, with a slight sheen to their surface. A standard speed would be roughly 800″ prints per hour. The material is in the heat tunnels long enough to reach to temperatures of the tunnel.

Once the web/deposit exits the heat tunnel, a permeable top sheet spunbond (Tyvek® 9, with an acrylic pressure sensitive adhesive on its bottom, should be adhered to the top of the printed assembly, and passed through at least one calendar roll to ensure adherence of the top sheet to the bottom sheet. Once done, the web can be slit and cut to produce discrete cards.

Cards are 2¾″ square, 2″ print with ⅜ inch on each edge not coated. One of the 2¾″ square cards is placed into an oxygen barrier pouch with 150 ml amount of oxygen and 2.0 g amount of water. After 48 hours, the oxygen is found to be at 0.0-1.27% level. The water is at 100% ERH. This illustrates the effectiveness as an oxygen absorber at high relative humidity.

### Example 2

The process of Example 1 is repeated except the cardstock is replaced with a sheet of styrene copolymer with butadiene of 2.5 mil thickness both sides of which have been Corona treated. Tests of the product are substantially the same as the cardstock base material of Example 1.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. An oxygen absorbing article comprising carbon, iron, refined wood pulp, and water.

2. The oxygen absorbing article of claim 1 wherein the article further comprises emulsifier.

3. The oxygen absorbing article of claim 1 wherein the carbon is present in an amount between 8 and 10% by weight.

4. The oxygen absorbing article of claim 1 further comprising a salt, wherein the salt is present in an amount between 1.5 and 5% by weight.

5. The oxygen absorbing article of claim 1 wherein the refined wood pulp is present in an amount of between 8 and 12% by weight.

6. The oxygen absorbing article of claim 1 wherein iron is present in an amount between about 40 and 60% by weight.

7. The oxygen absorbing article of claim 2 wherein the emulsifier comprises a polyoxyethylenesorbitan monoleate resin present in an amount of between 0.3 and 1% by weight.

8. The oxygen absorbing article of claim 1 wherein the carbon is present in an amount of between 8 and 12% by weight.

9. The oxygen absorbing article of claim 1 wherein the article is a label

10. An oxygen absorbing article comprising a base sheet, a cover sheet secured to said base sheet to define a closed space therebetween, a first layer of oxygen absorbing materials in integral layer form in said closed space, wherein the oxygen absorbing materials comprises carbon, iron, refined wood pulp, and water.

11. The oxygen absorbing article of claim 1 wherein the article further comprises emulsifier.

12. The oxygen absorbing article of claim 1 wherein the carbon is present in an amount between 8 and 10% by weight.

13. The oxygen absorbing article of claim 1 further comprising salt, and wherein the salt is present in an amount between 1.5 and 5% by weight.

14. The oxygen absorbing article of claim 1 wherein the refined wood pulp is present in an amount of between 8 and 12% by weight.

15. The oxygen absorbing article of claim 1 wherein iron is present in an amount between about 40 and 60% by weight.

16. The oxygen absorbing article of claim 2 wherein the emulsifier comprises a polyoxyethylenesorbitan monoleate resin present in an amount of between 0.3 and 1% by weight.

17. The oxygen absorbing article of claim 1 wherein the carbon is present in an amount of between 8 and 12%.

18. The article of claim 1 further including an adhesive layer on the side of the base sheet opposite the oxygen absorbing layer.
